(19) United States
(12) Patent Application Publication
(10) Pub. No.: US 2025/0094679 A1
(43) Pub. Date: Mar. 20, 2025

(54) LOW-LEVEL FEEDBACK-GUIDED SCHEDULING FOR HIGH-LEVEL SYNTHESIS

(71) Applicant: DeepMind Technologies Limited, Mountain View, CA (US)

(72) Inventors: Zhigang Pan, Austin, TX (US); Hanchen Ye, Sunnyvale, CA (US); Xiaoqing Xu, Mountain View, CA (US); Christopher Daniel Leary, Sunnyvale, CA (US)

(21) Appl. No.: 18/825,059

(22) Filed: Sep. 5, 2024

Related U.S. Application Data
(60) Provisional application No. 63/538,525, filed on Sep. 15, 2023.

(51) Int. Cl. G06F 30/327

(52) U.S. Cl. CPC G06F 30/327

(57) ABSTRACT

The technology employs an iterative system of difference constraints (ISDC) approach that leverages low-level feedback from downstream tools to iteratively refine scheduling with respect to circuit design high-level synthesis. In each iteration, a number of subgraphs are extracted from an original computation graph and passed to selected downstream tools, e.g., for logic synthesis, placement and/or routing. The downstream tools' compilation results are extracted and fed back to a scheduler. With the feedback, the scheduler recalculates delay estimation between each pair of nodes in the original computation graph and prunes redundant scheduling constraints. As a result, the explorable design space is enlarged in the next iteration, leading to refined scheduling results. This feedback-guided approach is compatible with versatile design constraints and objectives, such as minimizing register usage given a targeted clock period, minimizing the clock period given a constrained area budget, etc., to provide improvements to the system operation.

### CROSS-REFERENCE TO RELATED APPLICATIONS

This application claims the benefit of and priority to U.S. Provisional Application No. 63/538,525, filed Sep. 15, 2023, the entire disclosure of which is incorporated herein by reference.

### BACKGROUND

Scheduling is one of the most important problems in circuit design high-level synthesis (HLS) that partitions a control dataflow graph (CDFG) into multiple clock cycles under the given timing and resource constraints. HLS is a compilation technique that converts high-level algorithmic descriptions (e.g., C/C++) into functionally-equivalent register-transfer level (RTL) hardware implementations (e.g., in Verilog). Scheduling is the key component of HLS that partitions a given computation graph into multiple pipeline stages such that the total register usage is minimized while no individual pipeline stage between a node pair has a critical path longer than a specified clock period.

Various HLS tools rely on high-level intermediate representation (IR) for timing analysis, area/resource analysis, and scheduling. In this context, the IR operations, such as integer adder and multiplier, may be viewed as the fundamental elements to schedule against. Their delays and resources are pre-characterized in isolation through downstream tools, such as logic synthesizer for a target technology library. While this approach can capture some low-level characteristics of individual operations, it does not model further optimizations in downstream tools, leading to estimations that are substantially different from the actual quality of results (QoR). Thus, such approaches can result in insufficient and/or ineffective solutions.

### SUMMARY

Aspects of the technology employ an iterative system of difference constraints (ISDC) approach for HLS that leverages low-level feedback from downstream tools, such as logic synthesizers, to iteratively refine HLS scheduling.

The technology provides a drastically new way to perform HLS by introducing an iterative scheduling method that leverages low-level feedback from downstream tools to refine the scheduling in an automated way. In each iteration, a number of subgraphs are extracted from the original computation graph and passed to downstream tools for logic synthesis, and optionally, placement and routing. The downstream tools' compilation results, e.g., the logic depth or the timing analysis of each subgraph, can be extracted and fed back to the scheduler. With the guidance of low-level feedback, the scheduler is able to recalculate the delay estimation between each pair of nodes in the computation graph and prune the redundant scheduling constraints. As a result, the explorable design space is enlarged in the next iteration, leading to refined scheduling results. This feedback-guided approach is compatible with versatile design constraints and objectives, e.g., minimizing register usage given a targeted clock period, minimizing the clock period given a constrained area budget, etc.

Technical innovations and benefits include: (1) an enhanced system of difference constraints (SDC) formulation that effectively integrates low-level feedback into the linear-programming (LP) problem; (2) a fanout and window-based subgraph extraction mechanism driving the feedback cycle; and (3) a no-human-in-loop ISDC workflow compatible with any downstream tools and process design kit (PDK). Evaluation results show that ISDC may reduce register number by an average of 28.5% compared to an existing industrial-strength open-source HLS tool that employs SDC scheduling.

According to one aspect of the technology, a computer-implemented method comprises: creating, by one or more processors, an initial pipeline comprising a set of nodes, the initial pipeline corresponding to a function to be implemented by an integrated circuit according to a set of constraints, in which adjacent pairs of nodes are each associated with a corresponding timing constraint; performing, by the one or more processors, subgraph extraction on the initial pipeline to obtain a set of combinational subgraphs; providing, by the one or more processors, the set of combinational subgraphs to one or more downstream tools, the one or more downstream tools including at least one of a logic synthesis tool, a placement tool or a routing tool; obtaining, by the one or more processors from the one or more downstream tools, a set of subgraph delays; and revising, by the one or more processors based on the obtained set of subgraph delays, the initial pipeline comprising the set of nodes to create an updated pipeline comprising an updated set of nodes, the updated pipeline corresponding to the function to be implemented by the integrated circuit according to the set of constraints, in which adjacent pairs of the updated set of nodes are each associated with a corresponding updated timing constraint. The method may further comprise fabricating the integrated circuit using the updated pipeline.

In one scenario, the method further comprises iteratively repeating the performing, providing, obtaining and revising steps until a scheduling result satisfies a set of metrics. Here, in each iteration: the subgraph extraction is performed on a current iteration of the updated pipeline to obtain an updated set of combinational subgraphs; providing the set of combinational subgraphs comprises providing the updated set of combinational subgraphs to the one or more downstream tools; obtaining the set of subgraph delays comprises obtaining an updated set of subgraph delays; and revising the initial pipeline comprises revising the updated pipeline.

Alternatively or additionally to any of the above, the updated pipeline may achieve a scheduling result that is not achieved by the initial pipeline. Alternatively or additionally to any of the above, the set of combinational subgraphs may be less than all the subgraphs for the initial pipeline. Alternatively or additionally to any of the above, each node of the set of nodes may represent an operation to be performed according to the function to be implemented.

Alternatively or additionally to any of the above, the function to be implemented may be associated with a linear programming problem. In this case, revising the initial pipeline to create the updated pipeline may include constructing an updated linear programming problem. Alternatively or additionally to any of the above, revising the initial pipeline to create the updated pipeline may include removing redundant timing constraints. Alternatively or additionally to any of the above, the set of constraints may comprise timing constraints associated with the set of nodes. Here, the timing constraints may correspond to a target clock period.

Alternatively or additionally to any of the above, the set of constraints may be expressed in integer-difference form. Alternatively or additionally to any of the above, revising the initial pipeline to create the updated pipeline may include performing delay updating of estimated critical path delays for the node pairs. Here, revising the initial pipeline to create the updated pipeline may further include reformulating each corresponding timing constraint.

According to another aspect of the technology, a processing system is provided that, comprises memory configured to store information associated with fabrication of an integrated circuit, and one or more processors operatively coupled to the memory. The one or more processors are configured to create an initial pipeline comprising a set of nodes, in which the initial pipeline corresponds to a function to be implemented by the integrated circuit according to a set of constraints, in which adjacent pairs of nodes are each associated with a corresponding timing constraint. The one or more processors are also configured to: perform subgraph extraction on the initial pipeline to obtain a set of combinational subgraphs; provide the set of combinational subgraphs to one or more downstream tools, the one or more downstream tools including at least one of a logic synthesis tool, a placement tool or a routing tool; obtain, from the one or more downstream tools, a set of subgraph delays; and revise, based on the obtained set of subgraph delays, the initial pipeline comprising the set of nodes to create an updated pipeline comprising an updated set of nodes. The updated pipeline corresponds to the function to be implemented by the integrated circuit according to the set of constraints, in which adjacent pairs of the updated set of nodes are each associated with a corresponding updated timing constraint.

Alternatively or additionally to any of the above, the one or more processors may be further configured to generate an integrated circuit design using the updated pipeline in order to fabricate the integrated circuit. Alternatively or additionally to any of the above, the one or more processors may be further configured to iteratively repeat the perform, provide, obtain and revise operations until a scheduling result satisfies a set of metrics. Here, in each iteration: the subgraph extraction is performed on a current iteration of the updated pipeline to obtain an updated set of combinational subgraphs; provide the set of combinational subgraphs comprises providing the updated set of combinational subgraphs to the one or more downstream tools; obtain the set of subgraph delays comprises obtaining an updated set of subgraph delays; and revise the initial pipeline comprises revising the updated pipeline.

Alternatively or additionally to any of the above, the updated pipeline may achieves a scheduling result that is not achieved by the initial pipeline. Alternatively or additionally to any of the above, revision of the initial pipeline to create the updated pipeline may include removal of redundant timing constraints. Alternatively or additionally to any of the above, revision of the initial pipeline to create the updated pipeline may include performance of delay updating of estimated critical path delays for the node pairs.

### BRIEF DESCRIPTION OF THE DRAWINGS

FIG. 1A illustrates an exemplary integrated circuit design flow in accordance with aspects of the technology.

FIG. 1B illustrates a plot comparing post-synthesis STA versus XLS-estimated critical path delay.

FIG. 1C illustrates an example XLS stack diagram, which implements an HLS toolchain that produces synthesizable designs from flexible, high-level descriptions of functionality, for use with aspects of the technology.

FIG. 2 illustrates an exemplary flow of ISDC scheduling in accordance with aspects of the technology.

FIG. 3 illustrates an example of delay-based versus fanout-based subgraph extraction in accordance with aspects of the technology.

FIGS. 4A-B illustrate examples of cone-based versus window-based subgraph extraction in accordance with aspects of the technology.

FIG. 5 illustrates an example of a pseudocode algorithm of delay updating in accordance with aspects of the technology.

FIG. 6 illustrates an example of a pseudocode algorithm of SDC reformulation in accordance with aspects of the technology.

FIGS. 7A-C illustrate charts of an ablation study of delay-driven and fanout-driven subgraph extraction according to a path-based strategy, for 4 subgraphs, 8 subgraphs and 16 subgraphs per iteration, respectively, in accordance with aspects of the technology.

FIGS. 8A-C illustrate charts of an ablation study of path (dashed lines), cone (dotted lines), and window-based (solid lines) subgraph extraction according to a path-based strategy, for 4 subgraphs, 8 subgraphs and 16 subgraphs per iteration, respectively, in accordance with aspects of the technology.

FIG. 9 illustrates a table of benchmarking results in accordance with aspects of the technology.

FIG. 10 illustrates a plot of delay estimation accuracy comparison across a series of benchmarks in comparison to SDC, in accordance with aspects of the technology.

FIG. 11 illustrates a plot comparing post-synthesis STA versus ABC AIG depth of 6912 different HLS design points, in accordance with aspects of the technology.

FIGS. 12A-D illustrate an example approach in accordance with aspects of the technology.

FIGS. 13A-B illustrate an exemplary system in accordance with aspects of the technology.

FIG. 14 is a flow diagram in accordance with aspects of the technology.

### DETAILED DESCRIPTION

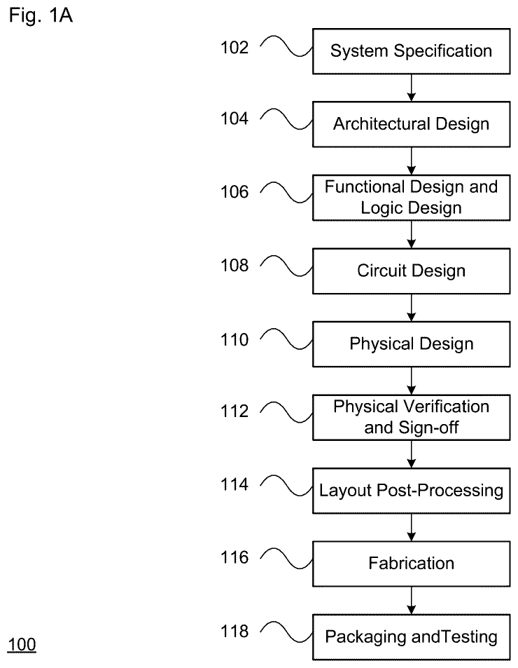

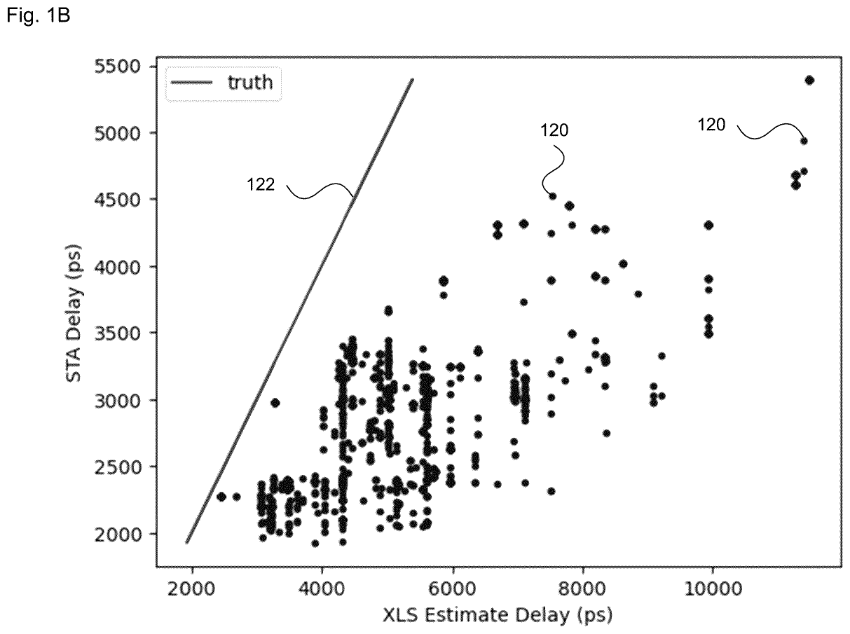

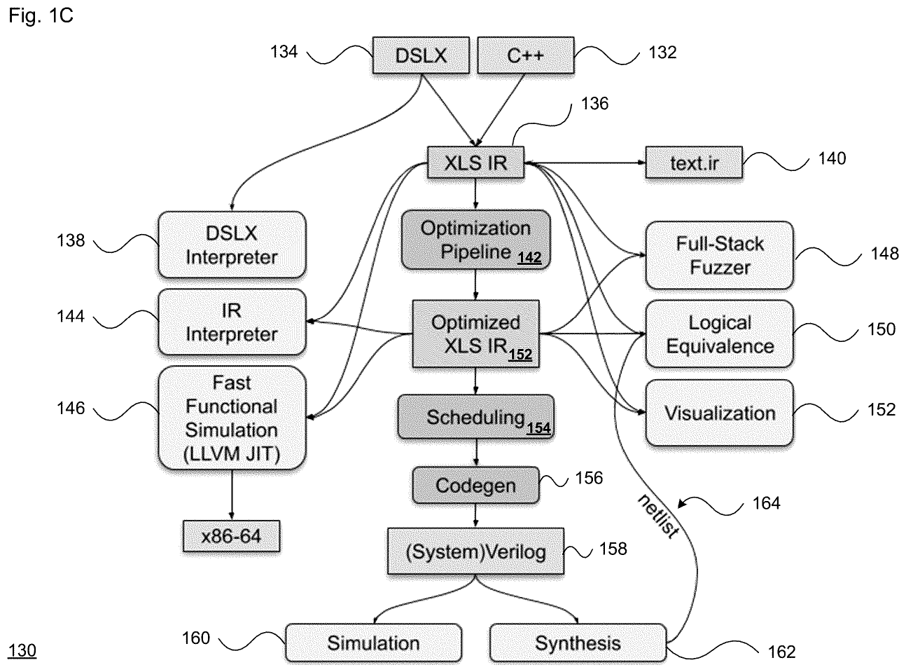

FIG. 1A illustrates an exemplary integrated circuit design flow 100 according to aspects of the technology, including generating a circuit design and/or fabricating an integrated circuit that incorporates any of the techniques discussed herein. As shown, the design flow may include preparing a system specification at block 102, such as to identify system-level requirements for the integrated circuit. The system specification is intended to capture the overall functionality of the desired integrated circuit. This may include determining the device's cost, performance, general architecture, how off-chip communication will be conducted, etc. The process flow may also include performing architectural design at block 104. At this stage, the design's architecture and its layout are determined by design engineers. This can include integration of memory management, analog and/or mixed-signal components, on-device and external communication, any power constraints, choice of process technology and/or layer stacks, etc.

The process flow continues with performing functional design and logic design at block 106, and performing circuit design at block 108. Functional design may include refinement of the design's specification to achieve the functional behavior of the desired system. Logic design involves adding the design's structure to a behavioral representation of the desired design. Here, considerations include logic minimization, performance enhancement, as well as testability. This stage may consider problems associated with test vector generation, error detection and correction, and the like. By way of example, the functional design and logic design may include generating a behavioral model description (e.g., using HDL) and floor-planning. During circuit design, logic blocks are replaced by corresponding electronic circuits, which may include devices such as resistors, capacitors, and/or transistors. At this stage, circuit simulation may be performed in order to verify timing behavior and other constraints of the system. A SPICE tool or other program may be used for circuit simulation.

Once the circuit design is complete, physical design may be performed at block 110 (e.g., component and wiring placement and routing), followed by physical verification and sign-off at block 112 (e.g., to obtain GDSII information with shapes to form the masks used to create the layers for fabricating the integrated circuit). During physical design, the actual layout of the integrated circuit is performed. Here, all of the components are placed and interconnected using metal interconnections. During this stage, the system may perform optimization of curvilinear interconnects, alternatively or additionally to any other layout operations. A circuit design that is able to pass testing of a circuit simulator in the circuit design stage may be found to be faulty after it has been packaged, e.g., due to geometric design rule issues. Thus, physical design rules are followed to ensure correctness during chip fabrication. Errors may include short or open circuits, open channels, or other issues may result when physical design rules are not followed. During physical verification and sign-off, the system performs any verification steps that are required before chip manufacturing. This can include design rule checking and correction, timing simulation, electromagnetic simulation, etc.

Layout post-processing occurs at block 114, then fabrication at block 116, and the packaging and testing at block 118. At block 114, the layout post-processing may include geometry processing before actual manufacturing, e.g., any dummy fill insertion, correction for optical proximity, mask optimization, etc. Fabrication comprises semiconductor manufacturing, which includes stages such as lithography patterning (masking), baking or annealing, etching, etc. Then the raw die of the chip is inserted into a package and I/O pins are connected to the package at block 118. Testing of the chip also occurs at this stage.

Certain HLS techniques rely on intermediate representation (IR) for timing analysis, area/resource analysis, and scheduling. In this context, the IR operations, such as integer additions and multiplications, can be viewed as the fundamental elements to schedule against. Their delays and resources may be pre-characterized in isolation through downstream tools, such as a logic synthesizer, for the target technology library. While this can capture some low-level characteristics of individual operations, it does not model further optimizations in downstream tools, such as logic resubstitution and rewriting, leading to estimations that can be substantially different from the actual quality of results (QoR).

An example of this can be seen in the plot of FIG. 1B. This figure presents design points of an HLS design using an accelerated HLS approach (“XLS”), which profiles post-synthesis static timing analysis (STA) and XLS-estimated critical path delays. The critical path is the longest path between a selected pair of nodes, which can determine a minimum clock period or a maximum operating frequency for the design. It can be composed of a series of logic gates, interconnects, registers or other nodes that have the highest cumulative delay. In particular, FIG. 1B presents post-syntheses STA versus XLS-estimated critical path delays of 6,912 different HLS data points. It can be observed that the XLS-estimated delays (dots 120) exhibit significant deviation from the STA delays (line 122), which were treated as the ground truth for the evaluation. These deviations create unused slack and present numerous opportunities to refine scheduling quality, such as reducing register usage. However, without access to low-level information, HLS tools may not effectively capitalize on these opportunities.

FIG. 1C illustrates an example 130 of an XLS stack workflow. Inputs in one or both of a programming language such as C++, as shown in block 132, or a domain-specific language (DSL) such as DSLX, as shown in block 134, are input to an XLS IR, as shown in block 136, to obtain an intermediate representation. DSLX provides immutable expression-language dataflow DSL with hardware-oriented features; e.g. arbitrary bit widths, entirely fixed size objects, and a fully analyzable call graph. DSLX may also be input to a DSLX interpreter, as shown in block 138.

The XLS IR block may provide a definition, text parser/formatter, and facilities for abstract evaluation. The XLS intermediate representation may output a text file 140 and, as shown, the representation flows to an optimization pipeline block 142. The representation may also be provided to one or more of an IR interpreter module 144, a fast functional simulation module 146, a full stack fuzzer module 148, a logical equivalence module 150 and/or a visualization module 152. By way of example, the module 148 may comprise a whole-stack multi-process fuzzer that generates programs at the DSL level and cross-compares different execution engines (e.g., DSL interpreter, IR interpreter, IR JIT, and/or code-generated-Verilog simulator).

The fuzzer module 148 may be configured so that it can easily be run on different nodes in a cluster simultaneously and accumulate shared findings. This module may generate a sequence of randomly generated DSLX functions and a set of random inputs to each function. The visualization module 152 is configured to provide visualization tools to inspect the XLS compiler and system interactively. It may present the IR in text and graphical form side-by-side and enable interactive exploration of the IR.

Upon optimization at block 142, the resultant optimized XLS IR 152 can be provided to one or more of the IR interpreter module 144, the fast functional simulation module 146, the full stack fuzzer module 148, the logical equivalence module 150 and/or the visualization module 152. The optimized XLS IR 152 is provided to a scheduling block 154, and the output of that block flows to a codegen block 156. The scheduling block 154 may employ one or more scheduling algorithms to determine when operations should execute (e.g., which pipeline stage) in a clocked design. The codegen block 156 may be configured to generate a Verilog Abstract Syntax Tree (VAST) to generate Verilog or System Verilog operations and finite state machines (FSMs). VAST is built up by components call generators in the translation from XLS IR. The output from block 156 may be a hardware description 158 of the circuitry of interest, e.g., in Verilog, System Verilog or another format.

The description 158 can be provided to one or both of a simulation block 160 or a synthesis block 162. The simulation block 160 may include an interface that wraps Verilog simulators and generates Verilog testbenches for XLS computations. The synthesis block 162 may include an interface that wraps backend synthesis flows, so that tools can be retargeted between different hardware flows, e.g., ASIC and FPGA flows. Here, a netlist 164 may be passed from the synthesis block 162 to the logical equivalence module 150.

### Iterative SDC Scheduling

The HLS IR to be scheduled can be represented as a directed graph G. For each operation node v in graph G, SDC scheduling can define a variable s, to represent the time step in which the operation is scheduled into. By ensuring constraints in integer-difference form, such as:

$${s}_{u} - {s}_{v} \leq {d}_{u , v} \qquad ( 1 )$$

where d_{u,v} is an integer, a totally unimodular constraint matrix is derived, which is guaranteed to have integral solutions. A set of common HLS constraints can be expressed in the form of integer-difference constraints. Specifically, to meet the target clock frequency, a timing constraint is used to constrain the maximum combinational delay within a clock cycle. For the critical combinational path (CCP) connecting vᵢ₁ and vᵢₖ with the largest delay (the critical path delay), one can calculate its delay D(ccp(vᵢ_{₁}, vᵢ_{ₖ})) as Σₛ₌₁^{k}d(vᵢ_{ₛ}) where d(v) is the individual delay of v. For each operation pair vᵢ and vⱼ with D(ccp(vᵢ, vⱼ))>T_{clk}, where T_{clk} is the target clock period, one can construct a constraint as:

$${s}_{{v}_{i}} - {s}_{{v}_{j}} \leq - ( ⌈ \frac{D ( c c p ( {v}_{i} , {v}_{j} ) )}{{T}_{clk}} ⌉ - 1 ) \qquad ( 2 )$$

Equation 2 states that the combinational path with total delay exceeding the target clock period T_{clk} must be partitioned into at least [D(ccp(vᵢ_{₁}, vᵢ_{ₖ}))/T_{clk}] number of clock cycles.

### Overall Scheduling Flow

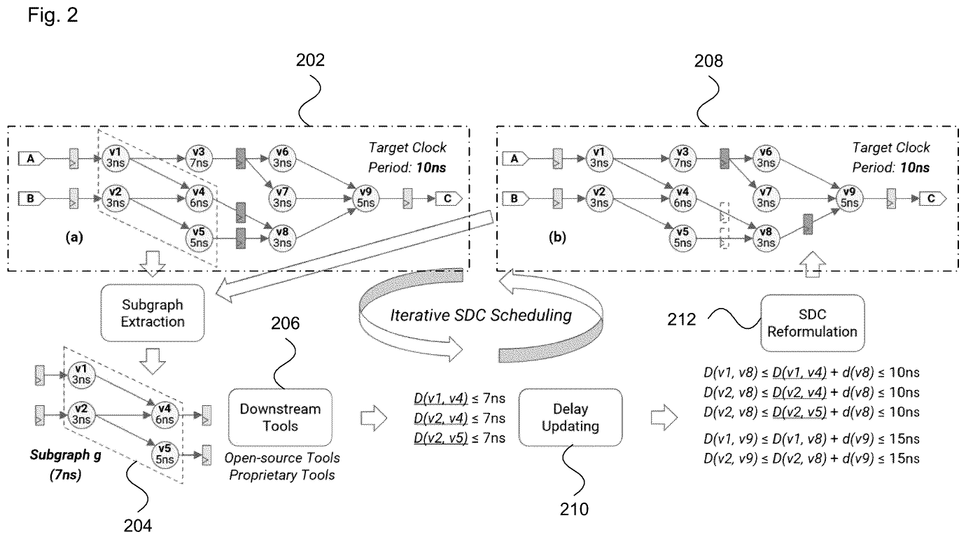

FIG. 2 shows an example 200 of the overall flow of an ISDC scheduling algorithm in accordance with aspects of the technology. ISDC starts from an initial pipeline, as depicted in the dash-dot block 202 of section (a) on the top left of the figure, scheduled with an original SDC scheduling algorithm. Note that each node in (a), e.g., nodes v1, v2, . . . , v9, represents an operation of the HLS IR, such as integer additions or multiplications. On top of this initial schedule, a set of combinational subgraphs, such as subgraph g at 204 along the lower-left of FIG. 2, are extracted and passed to downstream tools for subgraph logic synthesis and beyond.

Subsequently, the subgraph delays, e.g., of the form D(·), that are fed back from downstream tools 206 are integrated into an enhanced SDC formulation to construct an updated LP problem. The downstream tools may be open source or proprietary tools. Upon solving this LP problem, a new pipeline schedule is generated as depicted in section (b) at block 208. This procedure is then iteratively applied to the new pipeline schedule until a stable scheduling result is achieved, exemplified by metrics such as register usage. As illustrated, this iterative process includes delay updating at block 210 after usage of the downstream tool(s) 206, followed by SDC reformulation at block 212, which creates new delay constraints.

Downstream tools can include external logic synthesis tools, such as Yosys, which is an open-source framework for Verilog RTL synthesis. However, approaches according to aspects of the technology are also compatible with tools beyond logic synthesis tools, such as placement and routing tools, etc. Moreover, the system may monitor the number of constraints of a constructed linear programming (LP) problem to determine whether a stable scheduling result is achieved. For instance, if the number of constraints is no longer reduced in an iteration, which means the system is solving the same linear programming problem as the last iteration, the scheduling result will not be changed again.

Low-level feedback can be very beneficial. As shown in block 202 of section (a), the initial estimation of D(ccp(v₂, v₈)) is calculated as d(v₂)+d(v₄)+d(v₈), which totals to 12 ns. Given the target clock period of 10 ns, v₂ and v₈ must be scheduled into separate clock cycles. However, suppose the delay of subgraph g reported by downstream tools is 7 ns. Then D(ccp(v₂, v₈)) can be recalculated as D(g)+d(v₈), equaling to 10 ns. As a result, v8 can now be merged into the same clock cycle as v₂, leading to a decrease in register usage as depicted in dash-dot block 208 of section (b). This underscores the significance of low-level feedback in refining scheduling result. Such feedback empowers ISDC to identify better design points that might have been erroneously overlooked by the original SDC scheduling algorithm.

Considering the real-world constraints of computational resources, it is infeasible to evaluate every subgraph in an HLS design for feedback, especially given the exponential increase in complexity as the HLS design grows. By using an iterative approach, ISDC can capitalize on knowledge from prior iterations, substantially reducing the search space of subgraph extraction by focusing on combinational subgraphs from the previous schedule. This approach helps ISDC incrementally refine the scheduling result, maintaining manageable computational complexity throughout each iteration.

### Subgraph Extraction Strategy

Despite using an iterative approach, the number of subgraph candidates typically remains vast, which can readily result in slow convergence. There are different ways to address this problem, including a fanout-drive strategy and a window-based strategy.

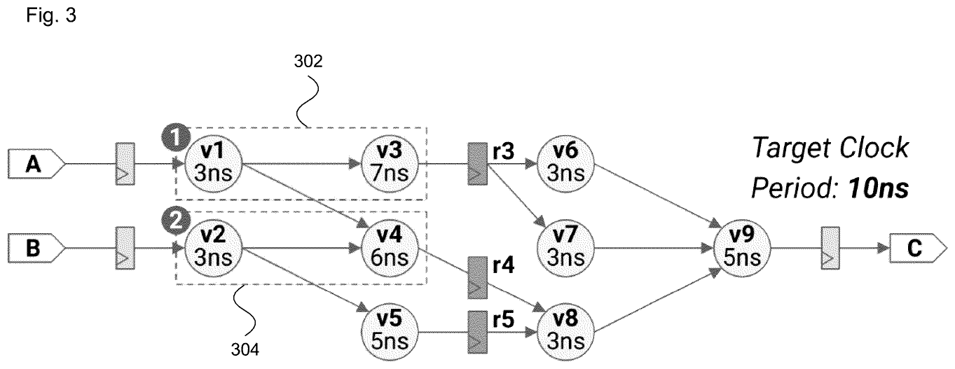

A direct and intuitive extraction strategy is delay-driven, in particular, focusing on the longest paths (e.g., critical paths) from the previous schedule because of their impact on the achievable clock frequency. Nonetheless, it can be appreciated that relying solely on delay is not the most effective strategy. Example 300 of FIG. 3 compares delay-based versus fanout-based subgraph extraction. As shown in this figure, path 1 in dotted section 302 is the longest combinational path with a delay of 10 ns. But the register associated with path 1, specifically r₃, is utilized by two (subsequent) consumer nodes, v₆ and v₇. Merging the two nodes into the first clock cycle would increase register usage, being not beneficial. In comparison, although path 2 in dotted section 304 has a shorter delay of 9 ns, its associated register r₄ only has a single consumer (node v₈), which offers greater flexibility in its positioning. Essentially, the more a register is being utilized, the more critical it becomes, reducing the benefit of repositioning it. Therefore, the following metric is introduced to drive the subgraph extraction process:

$$S ( {v}_{i} , {v}_{j} ) = {\sum }_{s = 1}^{k} \frac{{bit}_{count ( {r}_{s} ( {v}_{j} ) )} + \frac{D ( c c p ( {v}_{i} , {v}_{j} ) )}{{T}_{clk}}}{{num}_{users ( {r}_{s} ( {r}_{j} ) )} + 1} \qquad ( 3 )$$

Assuming vⱼ produces a total of k results, rₛ(vⱼ) denotes the s-th result of vⱼ. The function bit_count quantifies the significance of rₛ(vⱼ), while num_users captures the degree to which rₛ(vⱼ) is utilized. D(ccp(vᵢ, vⱼ))/T_{clk} serves as a tie-breaker, and is ensured to be less than 1.0 in any valid schedule. Suppose m subgraphs are extracted in each iteration. Here, ISDC sorts all combinational paths from the previous schedule in descending order of S(vᵢ, vⱼ) and extract the top m paths. Given that num_users can be viewed as the HLS IR level fanout, this approach is thus termed the fanout-driven strategy.

The importance of introducing feedback is to capture the low-level optimizations in downstream tools. To better capture inter-node optimizations, ISDC expands the paths identified above to “cones” and “windows”. Here, a cone is defined as a set of nodes at the HLS IR level with multiple input nodes (leaves) and a single output node (root). A cone must adhere to the following properties: (1) Each path from any primary input (PI) of graph G to root passes through a leaf; and (2) For each leaf, there exists a path from a PI to root that passes though that specific leaf and bypasses any other leaves. To expand a given path between nodes vᵢ and vⱼ into a combinational cone, ISDC uses a depth-first search (DFS) algorithm that recursively identifies the preceding nodes of vⱼ until it encounters the boundary nodes of clock cycles or the PI of the entire graph G.

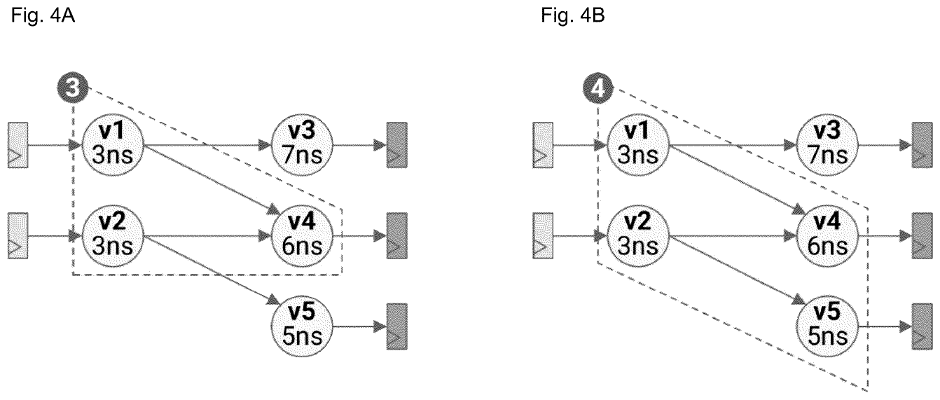

A window is derived by merging multiple cones that have different roots but share an identical or overlapping set of leaves. While a window still adheres to the properties above, it extends them to the case of multiple output nodes. FIG. 4A shows an example of expanding path 2 in FIG. 3 to a cone, here subgraph (3), while FIG. 4B shows a window, here subgraph (4). The cone/window subgraphs can capture the most relevant inter-operation optimizations, while also being sufficiently self-contained to mitigate the potential of over-optimization.

### Delay Updating

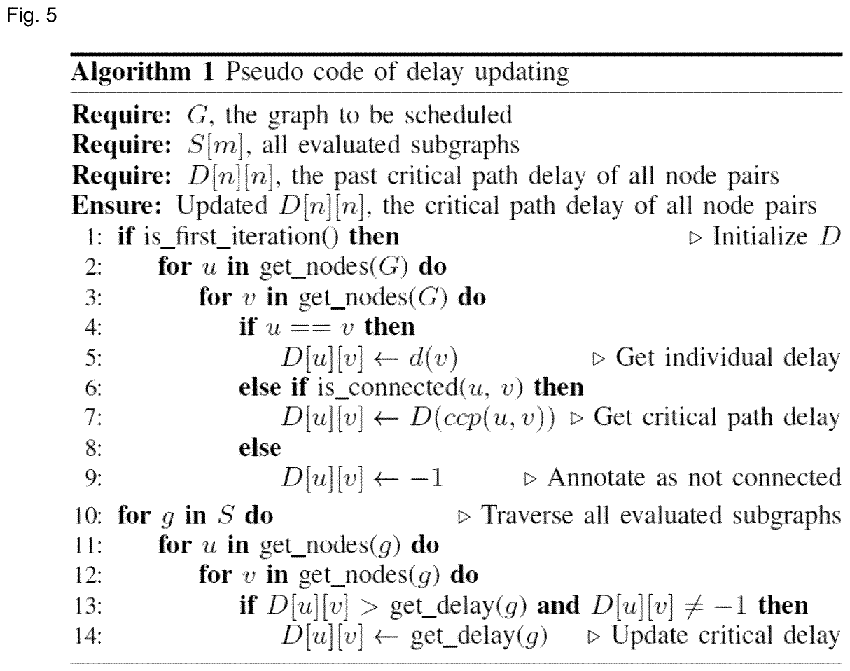

In the initial SDC scheduling phase, ISDC employs the method outlined above to calculate the critical path delay for every node pair and set timing constraints. To integrate the low-level feedback into the subsequent SDC formulations, ISDC maintains a matrix D[n][n] that holds the estimated critical path delay of all node pairs, where n denotes the total node count. In each iteration, ISDC updates D[n][n] according to the process shown in Algorithm 1 (see FIG. 5) once the subgraph delays are fed back from downstream tools. Lines 1 to 9 of Algorithm 1 initialize D[n][n] with the naive delay estimations. Subsequently, lines 10 to 14 traverse all evaluated subgraphs. For each subgraph g, the delay of all node pairs covered by g is updated with D(g), but only if D(g) is shorter than the original delay estimation. Consequently, ISDC maximally leverages the information obtained from each subgraph evaluation, thereby accelerating the iterative convergence.

### SDC Reformation

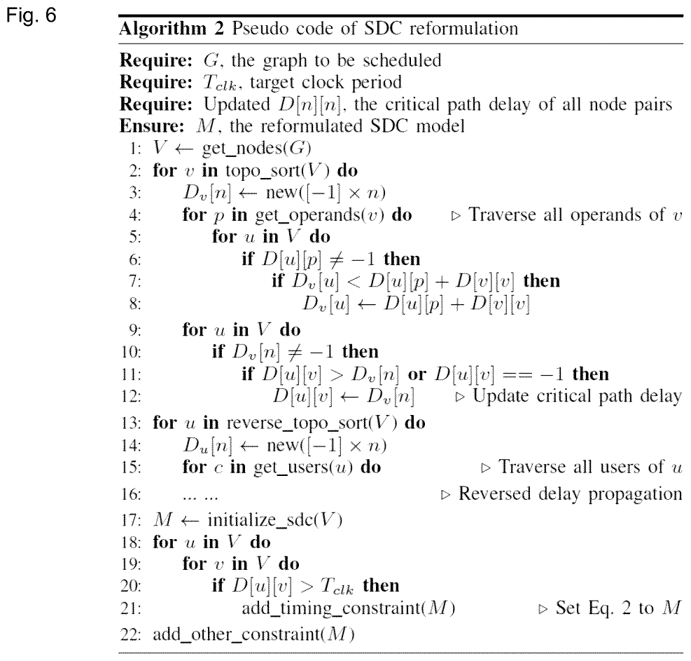

Upon the updated delay matrix D[n][n], all the timing constraints discussed above can be reformulated to construct an updated LP problem. Essentially, this reformulation can be viewed as an all-pairs shortest path problem, optimally solved by the Floyd-Warshall algorithm with a complexity of O(n³). To mitigate this cubic complexity, an O(n²) algorithm is presented as Algorithm 2 (FIG. 6), which provides a sufficiently accurate delay estimation. An estimation accuracy study is presented below. With regard to Algorithm 2, lines 2 to 12 traverse all nodes of graph G in a topological order, ensuring that a node is processed only after all its operand nodes. For a specific node v, lines 4 to 8 calculate the delay from all nodes to v by adding v's individual delay to the delay from all nodes to v's operand nodes. Lines 7 to 8 ensure only the critical path delay is recorded. Subsequently, lines 9 to 12 update D[n][n] only if the newly calculated delay is shorter.

After this topological order traversal, lines 13 to 16 of Algorithm 2 reprocess all nodes, but in a reversed topological order. This step aims to identify the complementary paths that cannot be identified by the initial topological order traversal. Finally, lines 18 to 21 set the timing constraints for the LP problem based on the recalculated D[n][n]. By reformulating the SDC problem, ISDC prunes the over-conservative timing constraints that were erroneously set in the previous SDC scheduling. This enlarges the updated LP problem's search space, naturally leading to a refined scheduling result.

### Testing and Evaluation

The ISDC approach was implemented on top of an industrial-strength open-source HLS tool, XLS, which uses SDC scheduling as the default scheduling algorithm. Logic synthesis used Yosys (as described by C. Wolf in “Yosys open synthesis suite”, 2016) and OpenSTA (as described in “OpenSTA: Parallax static timing analyzer”, 2023) for logic synthesis and STA. The open-source SKY130 (as described in “SkyWater open source PDK”, 2023) was used as the target technology library.

A set of ablation studies was performed on an XLS-based HLS design to demonstrate the efficacy of the fanout-driven and window-based subgraph extraction strategy.

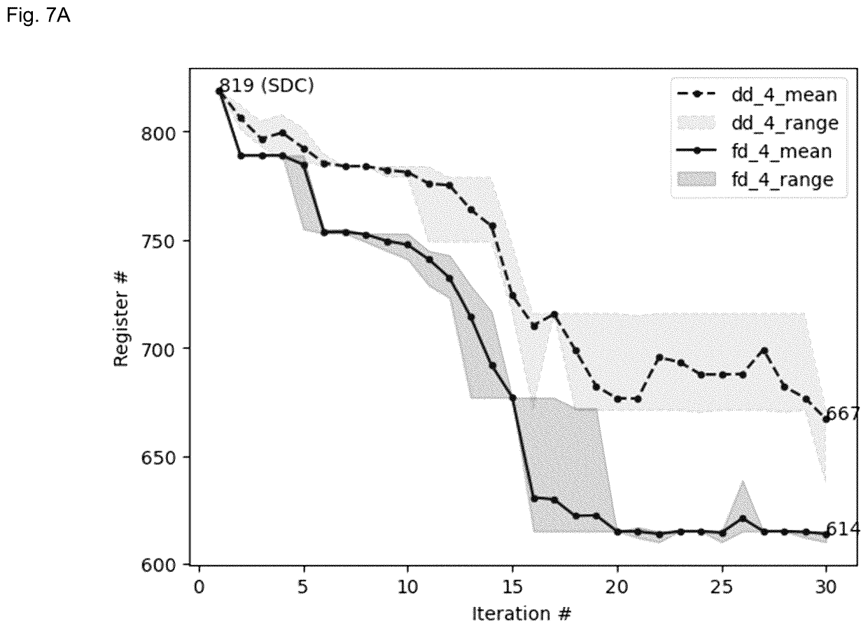

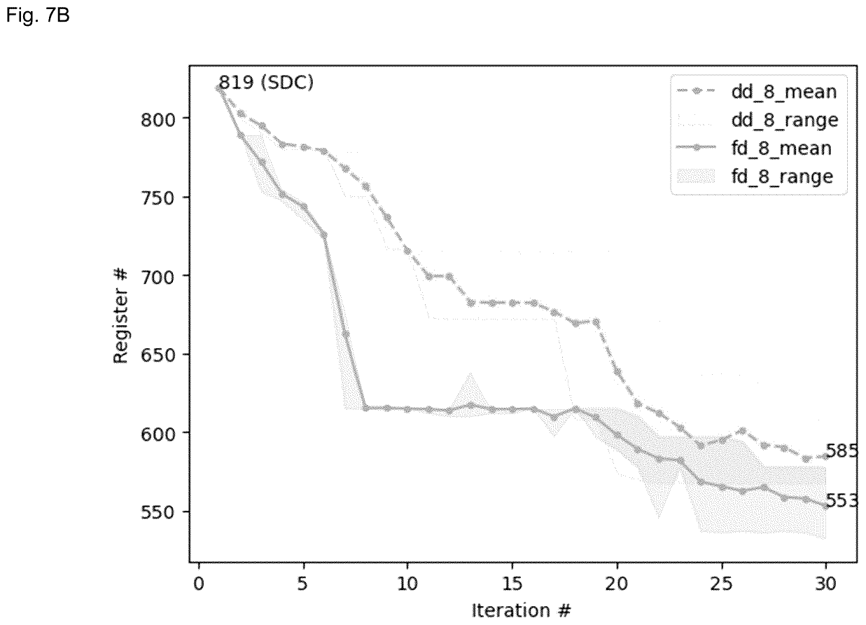

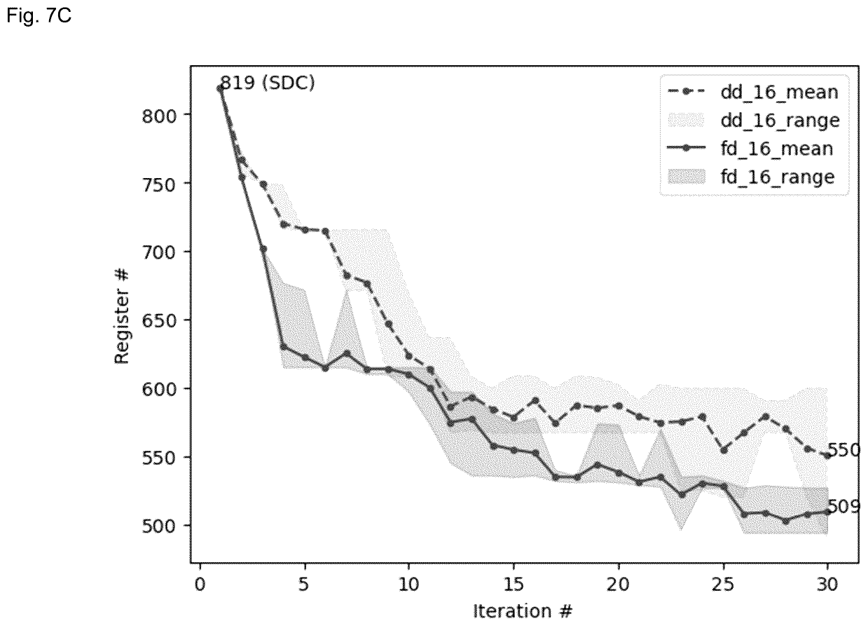

For the fanout-driven strategy, FIGS. 7A-C show the comparisons between the delay-driven (“dd”) and fanout-driven (“fd”) strategies. 30 iterations of scheduling were performed under 400 MHz clock frequency, where 4 (FIG. 7A), 8 (FIG. 7B), or 16 (FIG. 7C) subgraphs were extracted per iteration. The results indicate that the fanout-driven strategy converged notably faster than its delay-driven counterpart, particularly in the initial iterations. Furthermore, it consistently achieved lower register usage across all three cases.

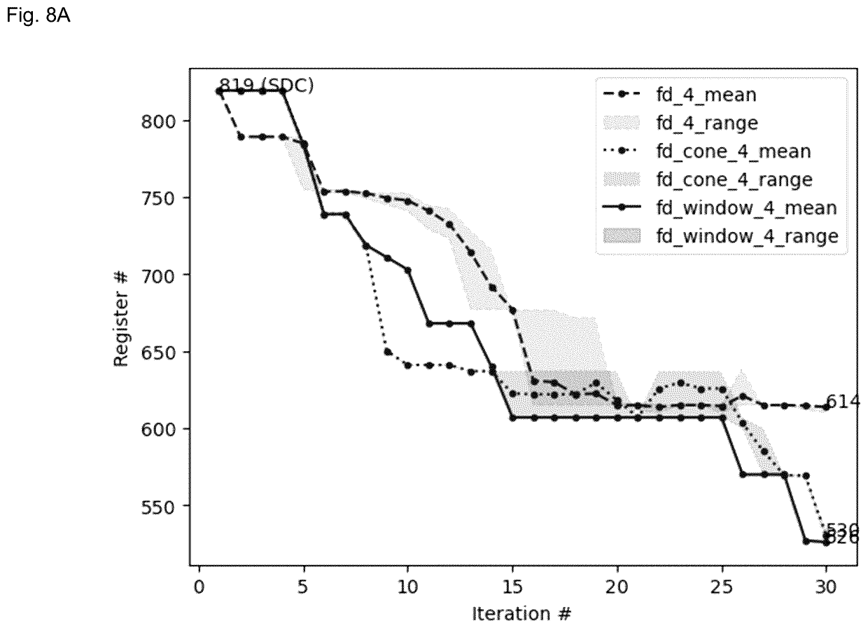

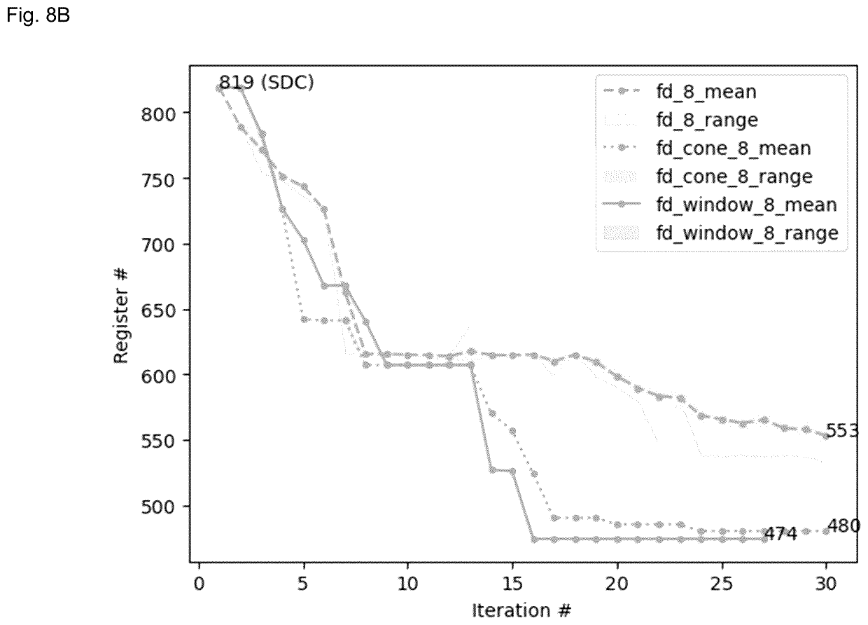

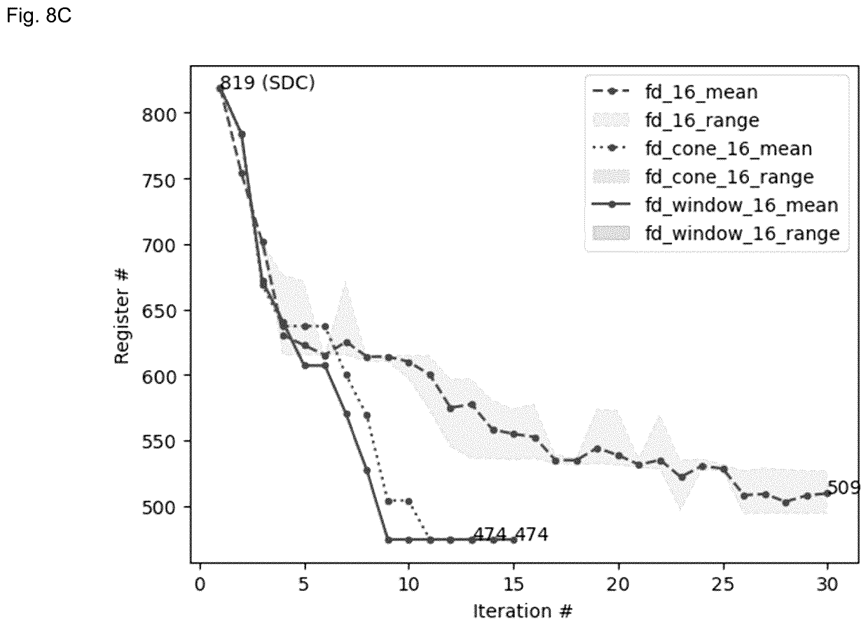

For the window-based strategy, FIGS. 8A-C show the comparisons among the path, cone, and window-based strategies for 4 subgraphs (FIG. 8A), 8 subgraphs (FIG. 8B), or 16 subgraphs (FIG. 8C) were performed for each iteration. Notably, the cone/window-based strategies demonstrated faster convergence than the path-based approach, achieving a reduced register usage. The path-based strategy may become trapped in local minima. In contrast, the cone/window-based strategy can overcome those points, achieving further improvements in subsequent iterations. While the cone and window-based strategies exhibit similar performance, the results suggest a slight edge for the window-based approach. Meanwhile, as expected, ISDC converged faster with the extraction and evaluation of more subgraphs per iteration.

Benchmarking was performed on 17 XLS-based HLS designs to evaluate ISDC. The benchmarks encompassed existing algorithms like crc32, as well as datapaths from industrial SoCs, including a machine learning processor (ML-core) and a video processor (video-core). In the evaluation, the fanout-driven and window-based strategies were used, evaluating 16 subgraphs per iteration in parallel. A total of 15 iterations were performed on each benchmark.

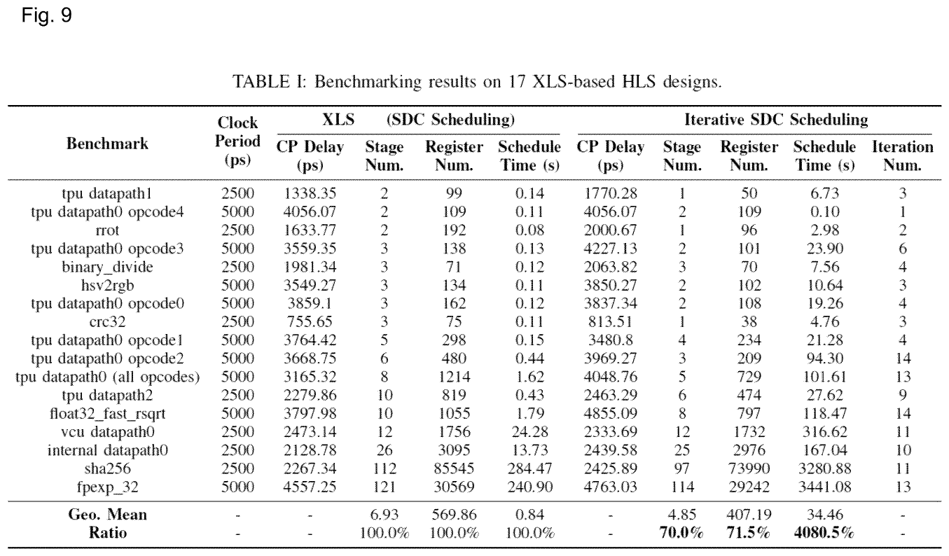

Table I (FIG. 9) shows the evaluation results, including metrics such as the target clock period, post-synthesis slack, number of pipeline stages, number of registers, and scheduling runtime. The bottom of the table shows results according to geometric mean and according to ratio. By default, the target clock period was set to 2500 ps to constrain the scheduling. If an operation in a benchmark exhibited an individual delay exceeding 2500 ps, the target clock period was adjusted to 5000 ps. On average, ISDC achieved a 28.5% lower register usage compared to the original SDC scheduling. This came at the cost of an average 40.8× increase in scheduling runtime. For instance, for the largest benchmark, sha256, ISDC spent around 54.7 minutes to converge, which was 11.5× longer than the original SDC's 4.7 minutes. Among all benchmarks, ISDC utilized 39.1% additional slack in average to make room for the reduction in register usage. However, there are several counter examples, such as ML-core datapath0 opcode0, which exhibited a slight increase in slack but still achieved a register usage reduction.

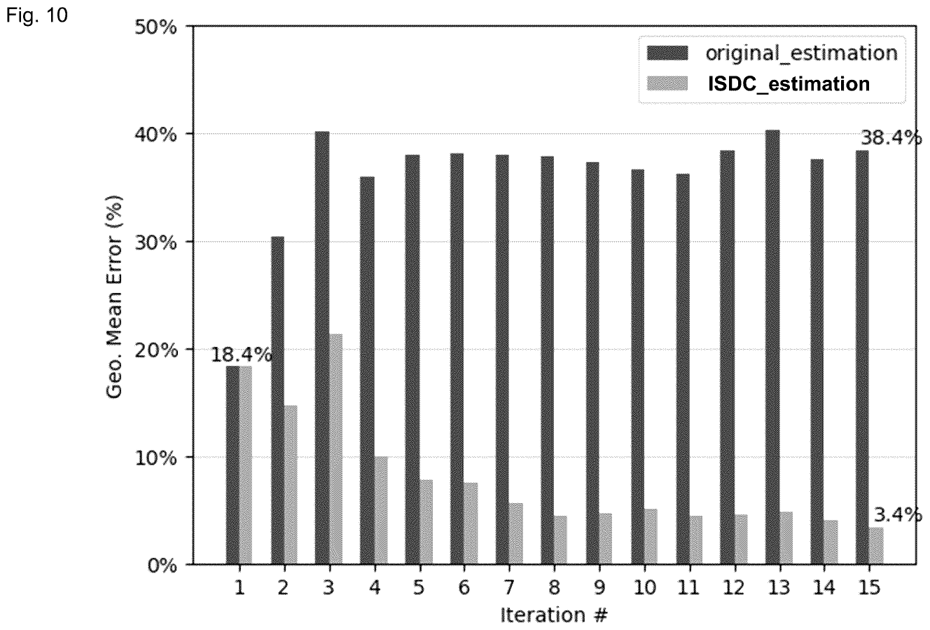

To evaluate ISDC's delay estimation accuracy, its estimation was analyzed across the 17 benchmarks from Table I and compared with the original SDC. FIG. 10 shows the results of the delay estimation accuracy comparison. In the first iteration, without low-level feedback, ISDC exhibited the same estimation error as the original SDC. However, as the iterations progressed, ISDC gradually reduced its estimation error, ultimately reaching an error of 3.4%. In contrast, the original SDC's estimation error increased, ending at 38.4%. This may be attributed to the fact that as the scheduling results are refined, more low-level optimizations are overlooked by the original SDC.

### Process Node Considerations:

Though real-world benchmarks were used for evaluation, they were evaluated down-clocked and on an older open-source industry process node (in particular, SKY130) to pioneer the methodology. It is expected that the improvements according to the aspects of the technology described herein should apply as effectively to more advanced process nodes and proprietary tools that offer similar STA report facilities.

### Retiming:

Retiming is a method that repositions registers in gate-level sequential circuits to optimize performance or reduce resource usage without altering the overall functionality. On the other hand, HLS scheduling operates at higher-level IRs composed with algebraic operations and explicit control flows. This provides HLS scheduling with greater flexibility and larger design space to find more optimized designs. Furthermore, HLS scheduling preserves the algebraic attributes in the generated circuits, paving the way for robust verification processes, such as logic equivalence checking. This mitigates the limitations inherent in the retiming technique.

### Runtime:

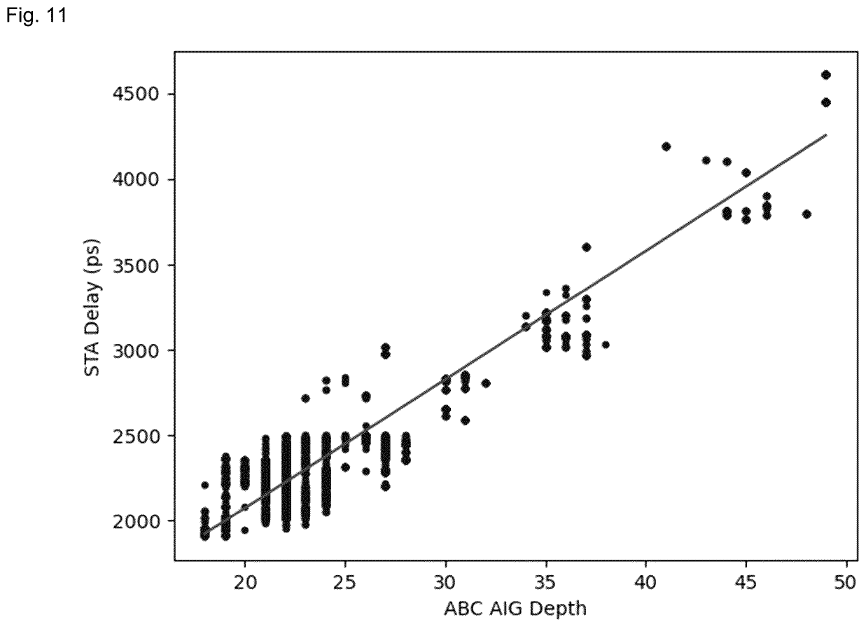

A common concern of feedback-guided approaches is runtime. While the results in Table I demonstrate that ISDC converges at a practical pace, a more aggressive strategy was explored using the and-inverter-graph (AIG) approach to guide the scheduling. AIG is a representation for logic optimizations. As shown in FIG. 11, which looked at 6,912 different HLS design points, there is a compelling linear correlation between post-synthesis STA delay and AIG depth within ABC (which is described by Brayton et al., in “ABC: An academic industrial-strength verification tool”, 2010). Thus, according to another aspect of the technology, the system may bypass time-consuming technology mapping and post-synthesis STA, and instead directly use AIG depth as feedback.

### Simultaneous HLS and Logic Optimization:

In ISDC, the back annotation technique may be bypassed due to its backend-specific nature and lack of generalizability. However, to squeeze out an extra bit of performance from digital circuits in the post-Dennard-scaling era, it can possible to blur the lines between HLS and downstream processes, such as logic synthesis. Thus, aspects of the technology may employ a co-optimization of the two design spaces, such as simultaneous HLS scheduling and logic optimization.

### Additional Example

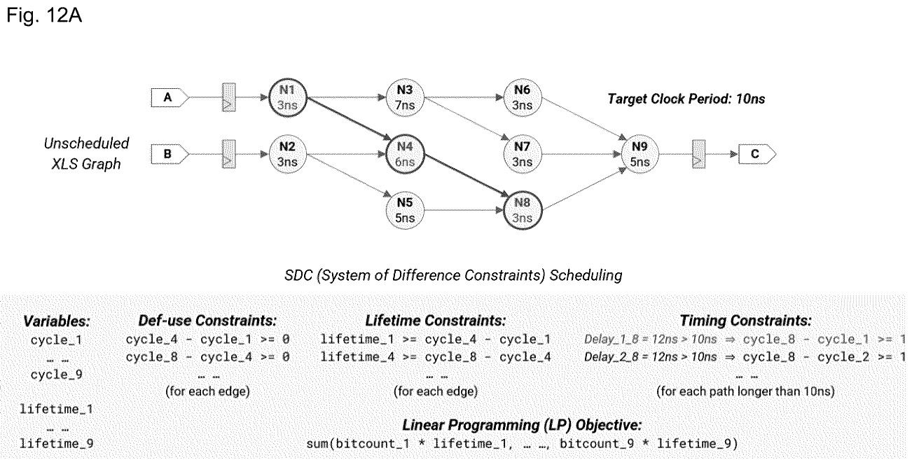

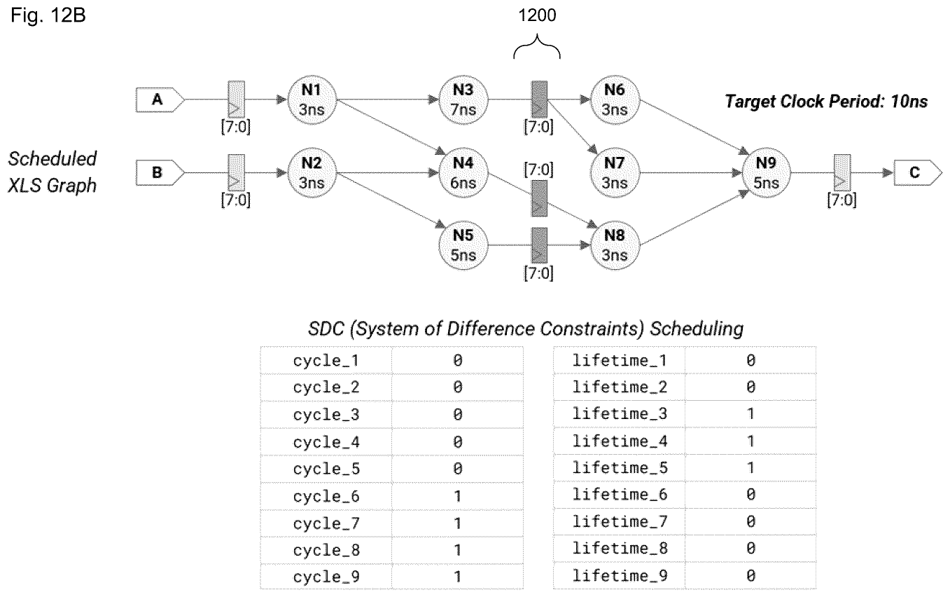

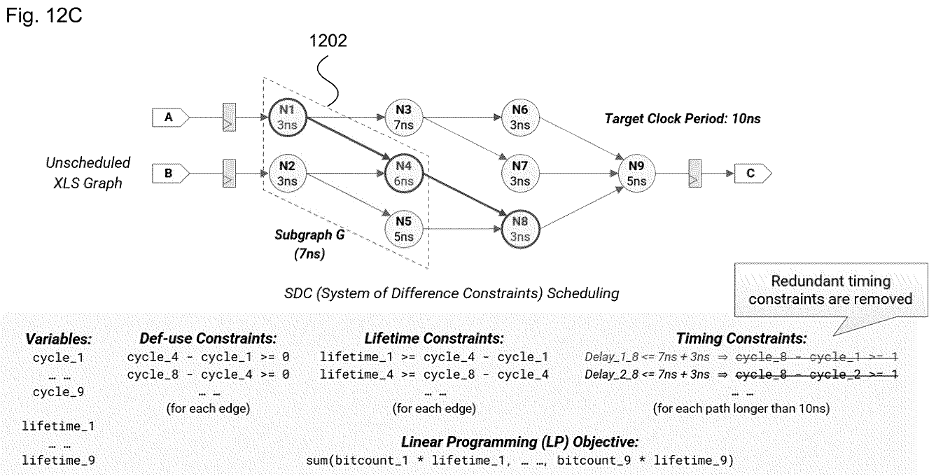

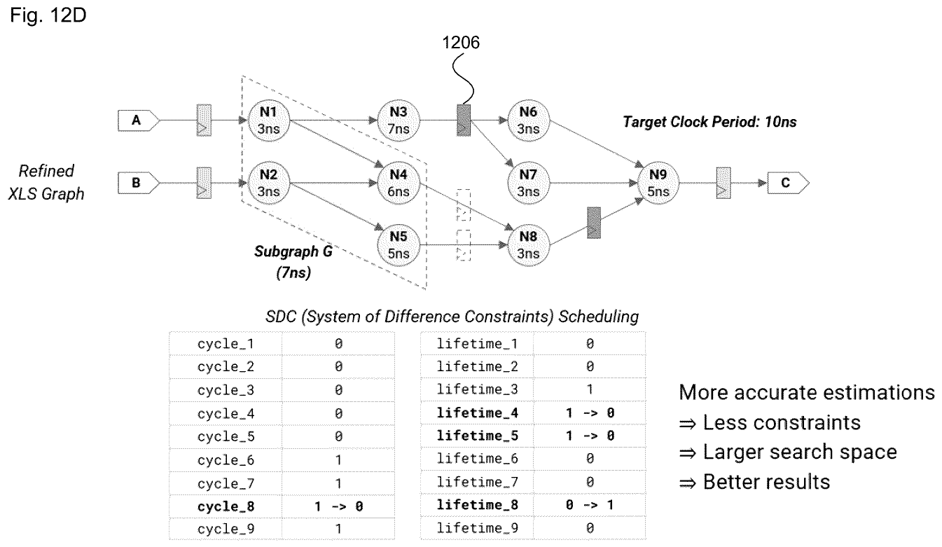

FIGS. 12A-D illustrate another example showing how original pipelined scheduling (e.g., in XLS) can be altered via ISDC to achieve fewer constraints using a larger search space to achieve better results that can be used to design and fabricate circuitry having a desired function. In particular, FIG. 12A illustrates an example of original pipeline scheduling in XLS. The example shows an unscheduled XLS graph with a targeted clock period (here, 10 ns) in the upper half of the figure. The lower half of the figure shows the various constraints, as well as the LP objective. These include define-usage constraints (“Def-use Constraints” in the figure). These constraints correspond to the scheduled cycle of a definer of a value that must be equal to or earlier than the cycle of a user of this value. Otherwise, the schedule is invalid.

As shown in FIG. 12A, the path along nodes N1 (3 ns), N4 (6 ns) and N8 (3 ns) exceeds the 10 ns timing constraint. Thus, as shown in FIG. 12B, a set of three registers 1200 would need to be inserted to accommodate the timing constraints.

In contrast, FIG. 12C illustrates an ISDC approach for reworking the pipelined scheduling. Here, as illustrated in the upper half of the figure, a window subgraph g (block 1202) can provide a more efficient and effective solution. In particular, subgraph g supports a 7 ns timing. If the system does not have any feedback, it would need to estimate the latency of subgraph g as 9 ns (3 ns for node 1+6 ns for node 4). However, with the feedback from downstream tools, they can provide the system with a more accurate estimation of subgraph g's latency, which is actually 7 ns in this example. The system then can leverage this more accurate information to refine the scheduling problem Thus, as shown in the bottom half of the figure, any redundant timing constraints are removed by the approach. The result of the iterative process is shown in FIG. 12D. A refined XLS graph is illustrated in the upper half of the figure, only a single register 1206 is needed in the upper portion of the graph. The lower half of the figure shows that certain of the requirements (e.g., cycle_8, lifetime_4, and lifetime_5) were satisfied while also utilizing fewer registers than the original approach.

### Example System

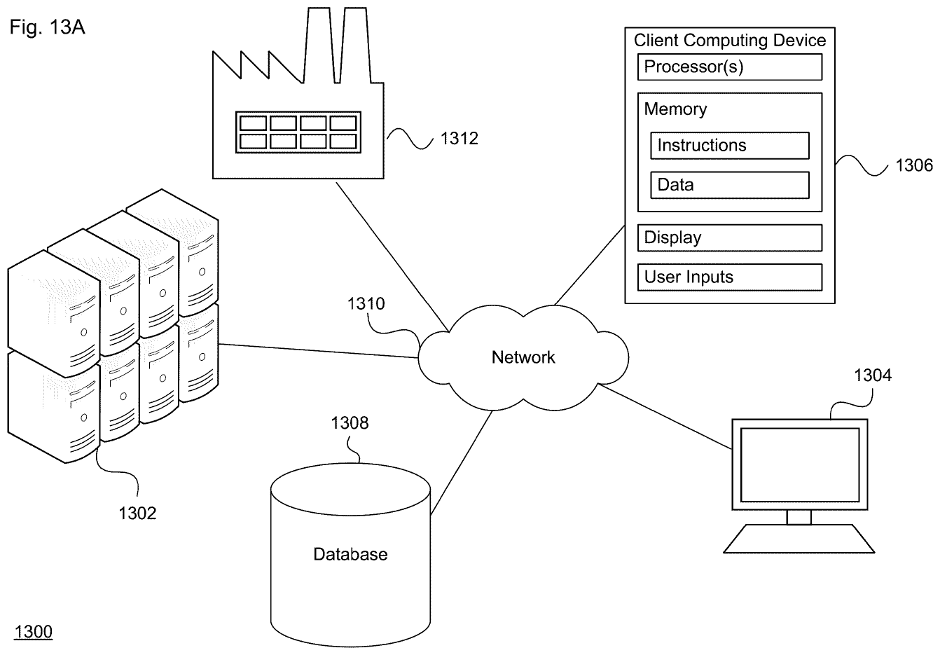

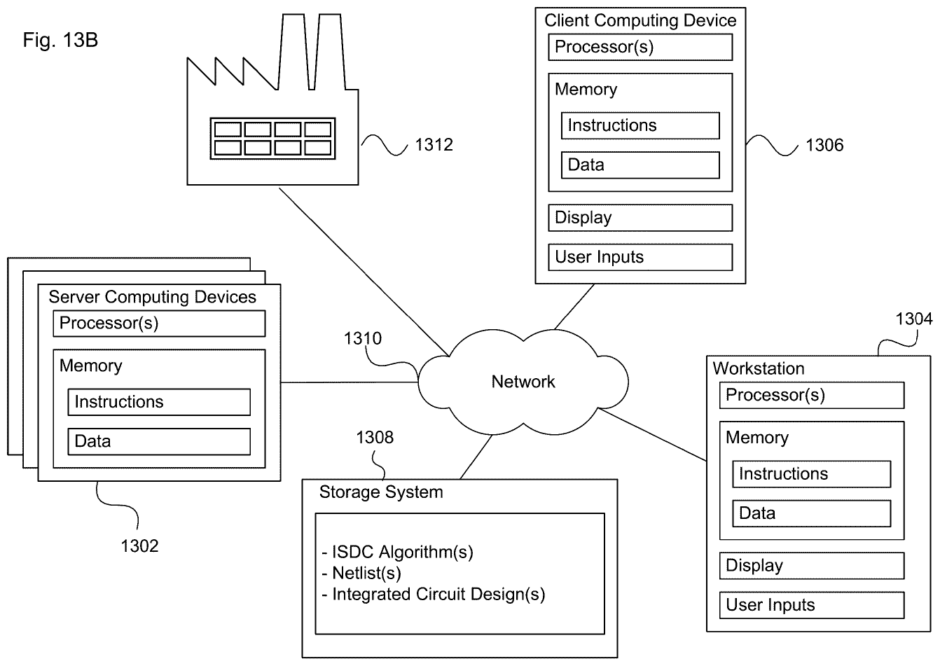

One example of a system configured to implement the ISDC technology discussed above is shown in FIGS. 13A-B. In particular, FIG. 13A is a block diagram and FIG. 13B is a functional diagram, of an example system 1300 that includes a plurality of computing devices 1302, 1304, 1306 and a storage system (e.g., a database) 1308 connected via a network 1310. System 1300 may also include a fabrication facility 1312 that is configured to produce circuitry designed according to the processes described herein. As shown in FIG. 13B, each of computing devices 1302, 1304 and 1306 may include one or more processors, memory, data and instructions.

By way of example, the one or more processors may be any conventional processors, such as commercially available central processing units (CPUs), graphical processing units (GPUs) or tensor processing unites (TPUs). Alternatively, the one or more processors may include a dedicated device such as an ASIC or other hardware-based processor. Moreover, reference to one or more processors or processing resources includes situations where a set of processors may be configured to perform one or more operations. Any combination of such a set of processors may perform individual operations or a group of operations, either sequentially or in parallel. This may include two or more CPUs, GPUs or TPUs (or other hardware-based processors) or any combination thereof. It may also include situations where the processors have multiple processing cores. Therefore, reference to one or more processors or processing resources does not require that all processors (or cores) in the set must each perform all of the operations. Rather, unless expressly stated, any one of the one or more processors (or cores) may perform different operations when a set of operations is indicated, and different processors (or cores) may perform specific operations, either sequentially or in parallel.

As shown in FIG. 13B, the memory for each computing device stores information accessible by the one or more processors, including instructions and data that may be executed or otherwise used by the processor(s). The memory may be of any type capable of storing information accessible by the processor, including a computing device or computer-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. The data may be retrieved, stored or modified by processor in accordance with the instructions. The data may also be formatted in any computing device-readable format. The algorithms, such as the pseudocode in FIGS. 5 and 6 may be implemented according to such instructions or programs. Moreover, any of the methods or processes discussed herein to implement the ISDC techniques may be implemented according to such instructions or programs.

The computing devices may include all of the components normally used in connection with a computing device such as the processor and memory described above as well as a user interface having one or more user inputs (e.g., one or more of a button, mouse, keyboard, touch screen, gesture input and/or microphone), various electronic displays (e.g., a monitor having a screen or any other electrical device that is operable to display information), and speakers. The computing devices may also include a communication system having one or more wired or wireless connections to facilitate communication with other computing devices of system 1300 and/or the fabrication facility 1312.

The various computing devices may communicate directly or indirectly via one or more networks, such as network 610. The network 1310 and any intervening nodes may include various configurations and protocols including short range communication protocols such as Bluetooth™, Bluetooth LE™, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

In one example, computing device 1302 may include one or more server computing devices having a plurality of computing devices, e.g., a load balanced server farm or cloud computing architecture, which exchange information with different nodes of a network for the purpose of receiving, processing, and transmitting the data to and from other computing devices. For instance, computing device 1302 may include one or more server computing devices that are capable of communicating with computing devices 1304, 1306 and the fabrication facility 1312 via the network 1310.

The computing devices may be configured to implement any of the ISDC techniques discussed herein. In some examples, client computing device 1304 may be an engineering workstation used by a developer to perform circuit design and/or other processes for integrated circuit design and fabrication. Client computing device 1306 may also be used by a developer, for instance to prepare system requirements for the integrated circuit or manage the manufacturing process with the fabrication facility 1312.

Storage system 1308 can be of any type of computerized storage capable of storing information accessible by the server computing devices 1302, 1304 and/or 1306, such as a hard-drive, memory card, ROM, RAM, DVD, CD-ROM, flash drive and/or tape drive. In addition, storage system 1308 may include a distributed storage system where data is stored on a plurality of different storage devices which may be physically located at the same or different geographic locations. Storage system 1308 may be connected to the computing devices via the network 1310 as shown in FIGS. 13A-B, and/or may be directly connected to or incorporated into any of the computing devices.

Storage system 1308 may store various types of information. For instance, the storage system 1308 may store one or more ISDC algorithms, netlists, RTL hardware implementations (e.g., Verilog, System Verilog, etc.) and/or other integrated circuit requirements. Alternatively or additionally, it may store the any final circuitry designs that may be provided for circuit fabrication by facility 1312.

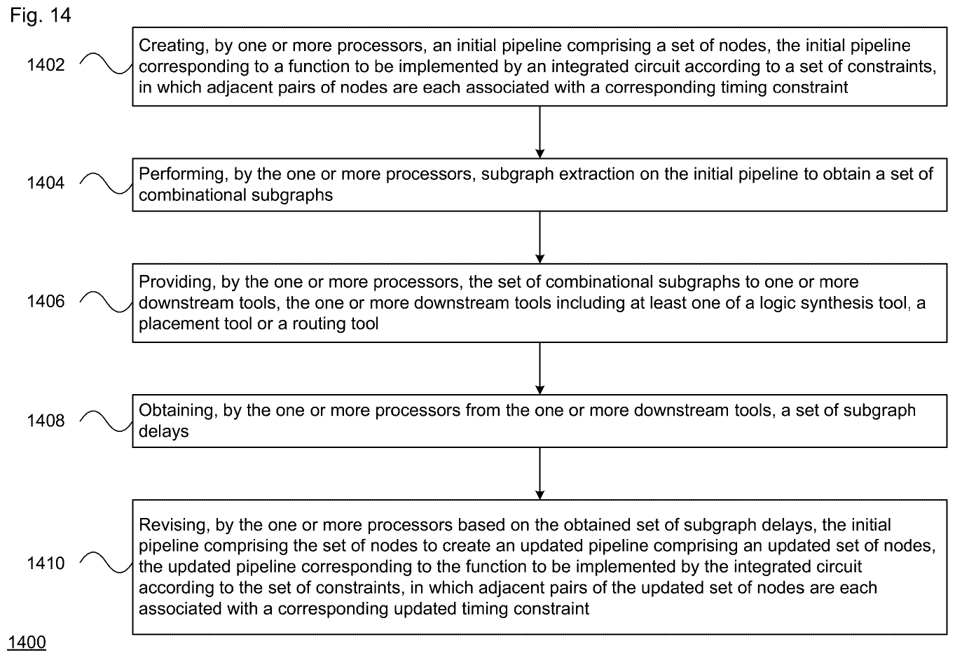

FIG. 14 illustrates a flow diagram 1400 of a computer-implemented method regarding aspects of the technology. At block 1402, this includes creating, by one or more processors, an initial pipeline comprising a set of nodes. The initial pipeline corresponds to a function to be implemented by an integrated circuit according to a set of constraints, in which adjacent pairs of nodes are each associated with a corresponding timing constraint. At block 1404, the method includes performing, by the one or more processors, subgraph extraction on the initial pipeline to obtain a set of combinational subgraphs. At block 1406, the method includes providing, by the one or more processors, the set of combinational subgraphs to one or more downstream tools, in which the one or more downstream tools includes at least one of a logic synthesis tool, a placement tool or a routing tool. At block 1408, the method includes obtaining, by the one or more processors from the one or more downstream tools, a set of subgraph delays. And at block 1410, the method includes revising, by the one or more processors based on the obtained set of subgraph delays, the initial pipeline comprising the set of nodes to create an updated pipeline comprising an updated set of nodes, the updated pipeline corresponding to the function to be implemented by the integrated circuit according to the set of constraints, in which adjacent pairs of the updated set of nodes are each associated with a corresponding updated timing constraint.

Although the technology herein has been described with reference to particular embodiments and configurations, it is to be understood that these embodiments and configurations are merely illustrative of the principles and applications of the present technology. It is therefore to be understood that numerous modifications may be made to the illustrative embodiments and configurations, and that other arrangements may be devised without departing from the spirit and scope of the present technology as defined by the appended claims.

1. A computer-implemented method, comprising:
creating, by one or more processors, an initial pipeline comprising a set of nodes, the initial pipeline corresponding to a function to be implemented by an integrated circuit according to a set of constraints, in which adjacent pairs of nodes are each associated with a corresponding timing constraint;
performing, by the one or more processors, subgraph extraction on the initial pipeline to obtain a set of combinational subgraphs;
providing, by the one or more processors, the set of combinational subgraphs to one or more downstream tools, the one or more downstream tools including at least one of a logic synthesis tool, a placement tool or a routing tool;
obtaining, by the one or more processors from the one or more downstream tools, a set of subgraph delays; and
revising, by the one or more processors based on the obtained set of subgraph delays, the initial pipeline comprising the set of nodes to create an updated pipeline comprising an updated set of nodes, the updated pipeline corresponding to the function to be implemented by the integrated circuit according to the set of constraints, in which adjacent pairs of the updated set of nodes are each associated with a corresponding updated timing constraint.

2. The method of claim 1, further comprising fabricating the integrated circuit using the updated pipeline.

3. The method of claim 1, further comprising iteratively repeating the performing, providing, obtaining and revising steps until a scheduling result satisfies a set of metrics;
wherein in each iteration:
the subgraph extraction is performed on a current iteration of the updated pipeline to obtain an updated set of combinational subgraphs;
providing the set of combinational subgraphs comprises providing the updated set of combinational subgraphs to the one or more downstream tools;
obtaining the set of subgraph delays comprises obtaining an updated set of subgraph delays; and
revising the initial pipeline comprises revising the updated pipeline.

4. The method of claim 1, in which the updated pipeline achieves a scheduling result that is not achieved by the initial pipeline.

5. The method of claim 1, wherein the set of combinational subgraphs is less than all the subgraphs for the initial pipeline.

6. The method of claim 1, wherein each node of the set of nodes represents an operation to be performed according to the function to be implemented.

7. The method of claim 1, wherein the function to be implemented is associated with a linear programming problem.

8. The method of claim 7, wherein revising the initial pipeline to create the updated pipeline includes constructing an updated linear programming problem.

9. The method of claim 1, wherein revising the initial pipeline to create the updated pipeline includes removing redundant timing constraints.

10. The method of claim 1, wherein the set of constraints comprises timing constraints associated with the set of nodes.

11. The method of claim 10, wherein the timing constraints correspond to a target clock period.

12. The method of claim 1, wherein the set of constraints are expressed in integer-difference form.

13. The method of claim 1, wherein revising the initial pipeline to create the updated pipeline includes performing delay updating of estimated critical path delays for the node pairs.

14. The method of claim 13, wherein revising the initial pipeline to create the updated pipeline further includes reformulating each corresponding timing constraint.

15. A processing system, comprising:
memory configured to store information associated with fabrication of an integrated circuit; and
one or more processors operatively coupled to the memory, the one or more processors configured to:
create an initial pipeline comprising a set of nodes, the initial pipeline corresponding to a function to be implemented by the integrated circuit according to a set of constraints, in which adjacent pairs of nodes are each associated with a corresponding timing constraint;
perform subgraph extraction on the initial pipeline to obtain a set of combinational subgraphs;
provide the set of combinational subgraphs to one or more downstream tools, the one or more downstream tools including at least one of a logic synthesis tool, a placement tool or a routing tool;
obtain, from the one or more downstream tools, a set of subgraph delays; and
revise, based on the obtained set of subgraph delays, the initial pipeline comprising the set of nodes to create an updated pipeline comprising an updated set of nodes, the updated pipeline corresponding to the function to be implemented by the integrated circuit according to the set of constraints, in which adjacent pairs of the updated set of nodes are each associated with a corresponding updated timing constraint.

16. The processing system of claim 15, wherein the one or more processors are further configured to generate an integrated circuit design using the updated pipeline in order to fabricate the integrated circuit.

17. The processing system of claim 15, wherein the one or more processors are further configured to iteratively repeat the perform, provide, obtain and revise operations until a scheduling result satisfies a set of metrics;
wherein in each iteration:
the subgraph extraction is performed on a current iteration of the updated pipeline to obtain an updated set of combinational subgraphs;
provide the set of combinational subgraphs comprises providing the updated set of combinational subgraphs to the one or more downstream tools;
obtain the set of subgraph delays comprises obtaining an updated set of subgraph delays; and
revise the initial pipeline comprises revising the updated pipeline.

18. The processing system of claim 15, in which the updated pipeline achieves a scheduling result that is not achieved by the initial pipeline.

19. The processing system of claim 15, wherein revision of the initial pipeline to create the updated pipeline includes removal of redundant timing constraints.

20. The processing system of claim 15, wherein revision of the initial pipeline to create the updated pipeline includes performance of delay updating of estimated critical path delays for the node pairs.
